(19) United States
(12) Patent Application Publication
(10) Pub. No.: US 2024/0267227 A1
(43) Pub. Date: Aug. 8, 2024

(54) SYSTEM AND OPERATING METHOD OF SYSTEM

(71) Applicant: TOYOTA JIDOSHA KABUSHIKI KAISHA, Toyota-shi (JP)

(72) Inventors: Marcelo FREITAS, Hino-shi (JP); Francesco DE LISI, Meguro-ku (JP); Michael PADDON, Shinjuku-ku (JP)

(73) Assignee: TOYOTA JIDOSHA KABUSHIKI KAISHA, Toyota-shi (JP)

(21) Appl. No.: 18/410,682

(22) Filed: Jan. 11, 2024

(30) Foreign Application Priority Data
Feb. 8, 2023 (JP) 2023-017888

(51) Int. Cl. H04L 9/32

(52) U.S. Cl. CPC H04L 9/3247; H04L 9/3268

(57) ABSTRACT

In a system including a terminal apparatus and a device configured to communicate with the terminal apparatus, the terminal apparatus is configured to generate a digital signature in response to a digital certificate signature request generated by the device, and the device is configured to transmit the digital certificate signature request, the digital signature, and a digital certificate to a server, the server having information that maps a user to the terminal apparatus, and to establish communication with the server on a condition that the digital certificate is authenticated by a certificate authority associated with the server.

### CROSS-REFERENCE TO RELATED APPLICATION

This application claims priority to Japanese Patent Application No. 2023-017888, filed on Feb. 8, 2023, the entire contents of which are incorporated herein by reference.

### TECHNICAL FIELD

The present disclosure relates to a system and an operating method of a system.

### BACKGROUND

The Internet of Things (IoT) connects various IoT devices, such as homes, vehicles, home appliances, and electronic devices, to the Internet, allowing them to transmit and receive information to and from each other and allowing the devices to be remotely controlled. To prevent spoofing and other illegal activities, technologies have been proposed for proving the authenticity of IoT devices when various IoT devices establish communication with server apparatuses and the like via the Internet. In relation to such technology, Patent Literature (PTL) 1, for example, discloses technology related to digital certificates for certifying the authenticity of IoT devices that communicate with other devices via the Internet or the authenticity of information that is transmitted and received.

### CITATION LIST

### Patent Literature

PTL 1: JP 6465426 B2

### SUMMARY

The procedure for obtaining certification of the authenticity of IoT devices is generally cumbersome and could thus be made more efficient.

It would be helpful to provide a system and the like that can improve the efficiency in acquiring certification of the authenticity of IoT devices.

A system in the present disclosure is a system including a terminal apparatus and a device configured to communicate with the terminal apparatus, wherein
the terminal apparatus is configured to generate a digital signature in response to a digital certificate signature request generated by the device, and
the device is configured to transmit the digital certificate signature request, the digital signature, and a digital certificate to a server, the server having information that maps a user to the terminal apparatus, and to establish communication with the server on a condition that the digital certificate is authenticated by a certificate authority associated with the server.

An operating method of a system in the present disclosure is an operating method of a system including a terminal apparatus and a device configured to communicate with the terminal apparatus, the operating method including:
generating, by the terminal apparatus, a digital signature in response to a digital certificate signature request generated by the device; and
transmitting, by the device, the digital certificate signature request, the digital signature, and a digital certificate to a server, the server having information that maps a user to the terminal apparatus, and establishing communication with the server on a condition that the digital certificate is authenticated by a certificate authority associated with the server.

According to the system and the like in the present disclosure, the efficiency in acquiring certification of the authenticity of IoT devices can be improved.

### BRIEF DESCRIPTION OF THE DRAWINGS

In the accompanying drawings:
FIG. 1 is a diagram illustrating an example configuration of an IoT system; and
FIG. 2 is a diagram illustrating an example of the operation procedures of each device in an IoT system.

### DETAILED DESCRIPTION

An embodiment will be described below with reference to the drawings.

FIG. 1 is a diagram illustrating an example configuration of an IoT system in an embodiment. The IoT system 1 includes one or more each of a device 11, a backend server 12, and an authentication server 13 that are communicably connected to each other via a network 14. The IoT system 1 also includes a terminal apparatus 10 that is configured to communicate directly with the device 11. Each device 11 mayfor example, be various home appliances, various sensor devices, and various housing equipment that have a communication function and an information processing function. The backend server 12 is, for example, a server computer that belongs to a cloud computing system or other computing system and functions as a server that implements various functions. The backend server 12 processes various information collected from the devices 11 and relays information exchange and control among devices 11. The authentication server 13 is a server of a certificate authority that performs authentication processing to ensure the authenticity of the device 11 when the device 11 connects to the backend server 12. The terminal apparatus 10 is a hardware token, an Integrated Circuit (IC) card, or the like that has a function to communicate directly with the device 11 in a wired or wireless manner and also processes and stores information necessary for authentication of the device 11. The network 14 is the Internet, for example, but may also include an ad-hoc network, a LAN, a Metropolitan Area Network (MAN), other networks, or a combination of two or more thereof.

In the present embodiment, in the IoT system 1, the terminal apparatus 10, the device 11, and the backend server 12 encrypt, transmit and receive, and decrypt various types of information based on public key cryptography. The terminal apparatus 10 generates a digital signature in response to a digital certificate signature request (hereinafter referred to as a Certificate Signature Request, or CSR), generated on and transmitted by the device 11, and transmits the digital signature to the device 11. The device 11 transmits the CSR, the digital signature, and a digital certificate to the backend server 12, which has information that maps a user to the terminal apparatus 10. Communication between the device 11 and the backend server 12 is established on the condition that the digital certificate is authenticated by a certificate authority associated with the backend server 12, i.e., by the authentication server 13. By having the terminal apparatus 10 communicate with the device 11, the user can acquire certification of the authenticity of the device 11 and establish a connection with the backend server 12 of the device 11 without directly inputting the information required for certification to the device 11. Thus, it is possible to improve the efficiency in acquiring certification of the authenticity of IoT devices.

Next, the configuration of each of the components of the IoT system 1 is described.

The terminal apparatus 10 includes a communication interface 101, a memory 102, a controller 103, and an input/output interface 104.

The communication interface 101 includes one or more interfaces for communication. The interface for communication is a wired interface such as

Universal Serial Bus (USB), or a short-range wireless interface such as

Bluetooth® (Bluetooth is a registered trademark in Japan, other countries, or both) or Near Field Communication (NFC), capable of communicating with the device 11.

The memory 102 includes, for example, one or more semiconductor memories, one or more magnetic memories, one or more optical memories, or a combination of at least two of these types. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM).

The controller 103 includes one or more processors, one or more dedicated circuits, or a combination thereof. Examples of the processor include a general purpose processor such as a Micro Processing Unit (MPU) and a dedicated processor dedicated to specific processing. The dedicated circuit is, for example, a field-programmable gate array (FPGA), an application specific integrated circuit (ASIC), or the like.

The input/output interface 104 includes an input interface that detects user input and transmits input information to the controller 103 and an output interface that outputs information, generated by the controller 103, to the user. The input interface is, for example, a physical key, a capacitive key, a touch screen integrally provided with a panel display, or the like. The output interface is, for example, a light that turns on and off according to information being outputted, a display for outputting information as images, a speaker for outputting information as audio, or the like.

The device 11 includes a communication interface 111, a memory 112, and a controller 113.

The communication interface 111 includes one or more interfaces for communication. The interface for communication is, for example, a wired or wireless LAN interface, an interface compliant with a mobile communication standard such as Long Term Evolution (LTE), 4th generation (4G), or 5th generation (5G), a wired interface such as USB capable of communicating with the terminal apparatus 10, or a short-range wireless interface such as Bluetooth or NFC. The communication interface 111 receives information to be used for the operations of the controller 113 from the terminal apparatus 10 and the backend server 12 and transmits information obtained by the operations of the controller 113.

The memory 112 includes, for example, one or more semiconductor memories, one or more magnetic memories, one or more optical memories, or a combination of at least two of these types, to function as main memory, auxiliary memory, or cache memory. The semiconductor memory is, for example, RAM or ROM. The RAM is, for example, SRAM or DRAM. The ROM is, for example, EEPROM. The memory 112 stores information to be used for the operations of the controller 113 and information obtained by the operations of the controller 113.

The controller 113 includes one or more processors, one or more dedicated circuits, or a combination thereof. Examples of the processor include a general purpose processor, such as a central processing unit (CPU) or an MPU, and a dedicated processor dedicated to specific processing. The dedicated circuit is, for example, an FPGA or an ASIC. The controller 113 executes information processing related to operations of the device 11 while controlling the components of the device 11.

The backend server 12 includes a communication interface 121, a memory 122, and a controller 123. The backend server 12 is, for example, a single computer. The backend server 12 maybe two or more computers that are communicably connected to each other and operate in cooperation. In this case, the configuration illustrated in FIG. 1 can be arranged among two or more computers as appropriate.

The communication interface 121 includes one or more interfaces for communication. The interface for communication is, for example, a wired or wireless LAN interface. The communication interface 121 receives information to be used for the operations of the backend server 12 and transmits information obtained by the operations of the backend server 12. The backend server 12 is connected to the network 14 by the communication interface 121 and communicates information with the device 11 and the authentication server 13 via the network 14.

The memory 122 includes, for example, one or more semiconductor memories, one or more magnetic memories, one or more optical memories, or a combination of at least two of these types, to function as main memory, auxiliary memory, or cache memory. The semiconductor memory is, for example, RAM or ROM. The RAM is, for example, SRAM or DRAM. The ROM is, for example, EEPROM. The memory 122 stores information to be used for the operations of the controller 123 and information obtained by the operations of the controller 123.

The controller 123 includes one or more processors, one or more dedicated circuits, or a combination thereof. The processor is a general purpose processor such as a CPU or a dedicated processor, such as a GPU, that is dedicated to specific processing. The dedicated circuit is, for example, an FPGA or an ASIC. The controller 123 executes information processing related to operations of the backend server 12 while controlling components of the backend server 12.

The functions of the backend server 12 are realized by a processor included in the controller 123 executing a control program. The control program is a program for causing a computer to execute the processing of steps included in the operations of the backend server 12, thereby enabling the computer to realize the functions corresponding to the processing of the steps. That is, the control program is a program for causing a computer to function as the backend server 12. Some or all of the functions of the backend server 12 maybe realized by a dedicated circuit included in the controller 103. The control program may be stored on a non-transitory recording/storage medium readable by the backend server 12 and be read from the medium by the backend server 12.

The authentication server 13 has the same configuration as the backend server 12. The authentication server 13 is configured by one or more computers.

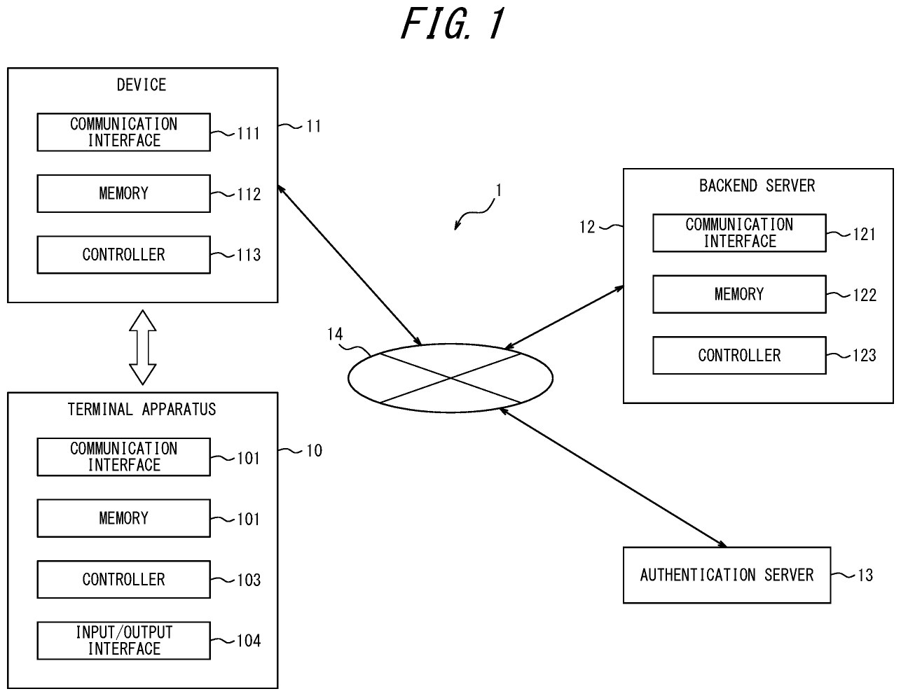

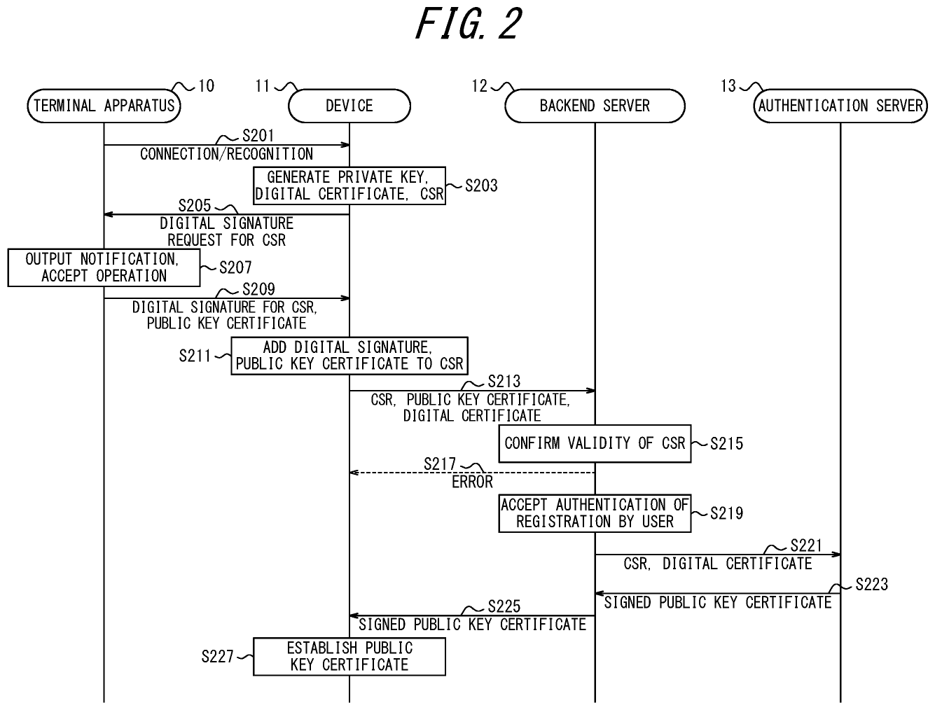

FIG. 2 is a sequence diagram illustrating an example of the operating procedures of the terminal apparatus 10, the device 11, the backend server 12, and the authentication server 13 in the IoT system 1. The steps pertaining to the various information processing by the terminal apparatus 10, the device 11, the backend server 12, and the authentication server 13 in FIG. 2 are executed by the respective controllers 103, 113, 123, and 123. The steps pertaining to transmitting and receiving various types of information are executed by the controllers 103, 113, 123, and 123 transmitting and receiving information to and from each other via the respective communication interfaces 101, 111, 121, and 121.

The procedure in FIG. 2 is the procedure when the user uses the terminal apparatus 10 to establish communication with the backend server 12 of the device 11. The procedure in FIG. 2 is initiated by the user physically connecting or bringing the terminal apparatus 10 close to the device 11.

By the terminal apparatus 10 being physically connected to the device 11 in step S201, the terminal apparatus 10 is recognized by the device 11, and information exchange with the device 11 becomes possible. Alternatively, short-range wireless communication may be used for the terminal apparatus 10 to be recognized by the device 11 and then to exchange information with the device 11.

In step S203, the device 11 generates a private key and public key, a digital certificate, and a CSR.

In step S205, the device 11 transmits a digital signature request for the CSR to the terminal apparatus 10. The terminal apparatus 10 generates the private key and the public key in advance, and the terminal apparatus 10 obtains authentication by acquiring a public key certificate containing the public key from the authentication server 13.

In step S207, in response to the digital signature request, the terminal apparatus 10 outputs a notification to the user prompting for a digital signature and accepts operation by the user. The notification is outputted by, for example, flashing lights, display of text information, audio output, or the like. Upon receiving notification of the digital signature request and accepting the digital signature, the user performs an operation corresponding to the acceptance. The user operation is, for example, touching or pressing an operation button or the like.

In step S209, the terminal apparatus 10 generates a digital signature by encrypting a CSR hash value with the private key of the terminal apparatus 10 in response to the operation by the user. The terminal apparatus 10 then transmits a public key certificate including a digital signature for the CSR and an authenticated public key to the device 11.

In step S211, the device 11 adds the digital signature and public key certificate received from the terminal apparatus 10 to the CSR.

In step S213, the device 11 transmits the CSR with the digital signature added thereto and the public key certificate received from the terminal apparatus 10 to the backend server 12.

In step S215, the backend server 12 confirms the validity of the CSR. The backend server 12 uses the authenticated public key of the terminal apparatus 10, included in the public key certificate transmitted from the device 11, to decrypt the digital signature added to the CSR and checks it against the hash value of the CSR to determine the validity of the CSR. The backend server 12 confirms the authenticity of the user on the condition that the public key certificate acquired from the terminal apparatus 10 via the device 11 matches the public key certificate acquired in advance from the authentication server 13. In a case in which the validity of the CSR is not confirmed, or the authenticity of the user is not confirmed, the backend server 12 notifies the device 11 of an error in step S217, and the procedure in FIG. 2 is terminated.

In step S219, the backend server 12 accepts authentication by the user. The user accesses the backend server 12 via the network 14 by any information processing apparatus, and identification information for the user is transmitted from the information processing apparatus to the server. The backend server 12 accepts the authentication by the user on the condition that the identification information transmitted by the user matches the information in the public key certificate. In this way, it is confirmed that the CSR of the device 11 has been digitally signed by use of the terminal apparatus 10 with which the authentic user has been associated in advance.

Once the authenticity of the user is confirmed, in step S221, the backend server 12 transmits the CSR and the digital certificate received from the device 11 to the authentication server 13. The digital certificate includes the public key generated by the device 11.

In step S223, the authentication server 13 acquires and authenticates the public key from the digital certificate of the device 11 and generates a public key certificate. The authentication server 13 digitally signs the public key certificate using the private key and transmits the signed public key certificate to the backend server 12.

In step S225, the backend server 12 transmits the signed public key certificate received from the authentication server 13 to the device 11.

In step S227, the device 11 acquires the signed public key certificate received from the backend server 12. The device 11 then establishes a public key certificate, i.e., its own public key that has been authenticated by the authentication server 13. In this way, the authenticity of the device 11 is confirmed.

According to the present embodiment, by having the terminal apparatus 10 communicate with the device 11, the user can acquire certification of the authenticity of the device 11 and establish a connection with the backend server 12 of the device 11 without directly inputting, to the device 11, the information required for certification of the device 11. Thus, it is possible to improve the efficiency in acquiring certification of the authenticity of IoT devices.

In FIG. 2, a case in which the device 11 establishes a connection with the backend server 12 is illustrated as an example. However, it is also possible to establish a connection between the device 11 and other IoT devices by having an IoT device other than the device 11 execute steps S213 to S225 instead of the backend server 12.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A system comprising a terminal apparatus and a device configured to communicate with the terminal apparatus, wherein
the terminal apparatus is configured to generate a digital signature in response to a digital certificate signature request generated by the device, and
the device is configured to transmit the digital certificate signature request, the digital signature, and a digital certificate to a server, the server having information that maps a user to the terminal apparatus, and to establish communication with the server on a condition that the digital certificate is authenticated by a certificate authority associated with the server.

2. The system according to claim 1, wherein on the server, the digital certificate signature request and the digital certificate are transmitted to the certificate authority, and an authenticated digital certificate transmitted from the certificate authority is transmitted to the device, on a condition that the digital signature corresponds to the information that maps the user to the terminal apparatus.

3. The system according to claim 2, wherein the device is configured to transmit the digital certificate signature request to the terminal apparatus upon recognizing the terminal apparatus in a wired or wireless manner.

4. An operating method of a system comprising a terminal apparatus and a device configured to communicate with the terminal apparatus, the operating method comprising:
generating, by the terminal apparatus, a digital signature in response to a digital certificate signature request generated by the device; and
transmitting, by the device, the digital certificate signature request, the digital signature, and a digital certificate to a server, the server having information that maps a user to the terminal apparatus, and establishing communication with the server on a condition that the digital certificate is authenticated by a certificate authority associated with the server.

5. The operating method according to claim 4, further comprising transmitting, on the server, the digital certificate signature request and the digital certificate to the certificate authority, and transmitting, to the device, an authenticated digital certificate transmitted from the certificate authority, on a condition that information included in the digital signature corresponds to the information that maps the user to the terminal apparatus.

6. The operating method according to claim 5, wherein the device transmits the digital certificate signature request to the terminal apparatus upon recognizing the terminal apparatus in a wired or wireless manner.
